(19) United States
(12) Patent Application Publication
(10) Pub. No.: US 2013/0176168 A1
(43) Pub. Date: Jul. 11, 2013

(54) Controlled access satellite navigation receiver

(71) Applicants: Sherman C. Lo, San Mateo, CA (US); David S. De Lorenzo, Palo Alto, CA (US); Chad Jennings, Seattle, WA (US)

(72) Inventors: Sherman C. Lo, San Mateo, CA (US); David S. De Lorenzo, Palo Alto, CA (US); Chad Jennings, Seattle, WA (US)

(21) Appl. No.: 13/687,875

(22) Filed: Nov. 28, 2012

Related U.S. Application Data
(60) Provisional application No. 61/583,598, filed on Jan. 5, 2012.

(51) Int. Cl. G01S 19/47; G01S 19/42

(52) U.S. Cl. CPC G01S 19/47; G01S 19/42
USPC 342/357.3; 342/357.25

(57) ABSTRACT

A controlled access satellite navigation receiver has only incomplete knowledge of secret codes transmitted by satellites. This incomplete knowledge allows only intermittent position determination. Incomplete secret codes and the intermittent positions they provide are useful for authenticating navigation signals or controlling access to secret satellite services.

### TECHNICAL FIELD

The disclosure is related to satellite navigation receivers.

### BACKGROUND

Satellite constellations have replaced the stars as reference points for navigation. The global positioning system (GPS) has been joined by other global navigational satellite systems (GNSS) including GLONASS, Galileo, and BeiDou. The Iridium constellation, while not primarily intended for navigation, provides voice and data service worldwide.

Many signals transmitted by GNSS are public. For example, GPS receivers have complete knowledge of the C/A code sent from GPS satellites. Receivers correlate internally generated C/A code replicas against C/A code signals received over the air to compute pseudoranges. On the other hand, GNSS also transmit secret codes. Galileo Public Regulated Service encrypted codes and GPS P(Y) code are examples of secret codes. P(Y) code replicas can be generated by properly keyed Selective Availability/Anti-Spoofing Module (SAASM) chips which are tightly controlled by the US military. Without a timely and correct P(Y) code replica, however, no pseudoranges can be computed and P(Y) signals are of limited use to a receiver.

Tremendous progress has been made in GNSS signal accuracy, availability and integrity; so much so that many people take GNSS service for granted and are unaware of how extensive their dependence on GNSS signals has become. Dependence on GNSS, for cellular phone system time distribution as just one example, creates a new area of concern: signal authenticity. GNSS signal simulators have become relatively inexpensive and knowledge of how to use them to spoof a GNSS receiver is spreading rapidly. A university team recently demonstrated taking control of an unmanned aerial vehicle by sending fake GPS signals to it.

A receiver that has access to secret signals cannot be spoofed because would-be malefactors do not know the secret codes. However, secret codes by definition cannot be widely disseminated lest they fall into the wrong hands. Satellite receivers for data services such as those provided by Iridium are also candidates for spoofing. Data receivers pay for access to secret satellite signals and thus such access must be controlled.

Hence, what are needed are satellite receivers whose access to secret signals can be precisely controlled or regulated without compromising secrecy.

### BRIEF DESCRIPTION OF THE DRAWINGS

FIG. 1 is a conceptual diagram of a controlled access satellite navigation receiver receiving a signal from an orbiting satellite.

FIG. 2A is a conceptual diagram of code segments separated by intervals.

FIG. 2B is a conceptual diagram of code segments correlated against a complete code.

FIG. 3 is a simplified block diagram of a controlled access satellite navigation receiver.

FIG. 4 is a snapshot of position uncertainties associated with different navigation systems.

FIG. 5 is a flow chart for a controlled access satellite navigation method.

FIG. 6 illustrates various code segment strategies.

### DETAILED DESCRIPTION

Controlled access satellite navigation receivers are designed to have incomplete knowledge of secret codes transmitted by satellites. This incomplete knowledge allows only intermittent position determination. As described below, however, incomplete secret codes and the intermittent positions they provide are useful for authenticating navigation signals or controlling access to private satellite services.

As used herein, “position” means (\vec{x}, t) or \vec{x} or t, where \vec{x}=(x, y, z). Discussion of position pertains equally to \vec{x} or t or components thereof. Further, an “INS” (inertial navigation system) by definition includes an IMU (inertial measurement unit) and/or a clock. Thus an INS estimates position. An IMU may provide accelerometer, gyroscope, altimeter and/or compass measurements.

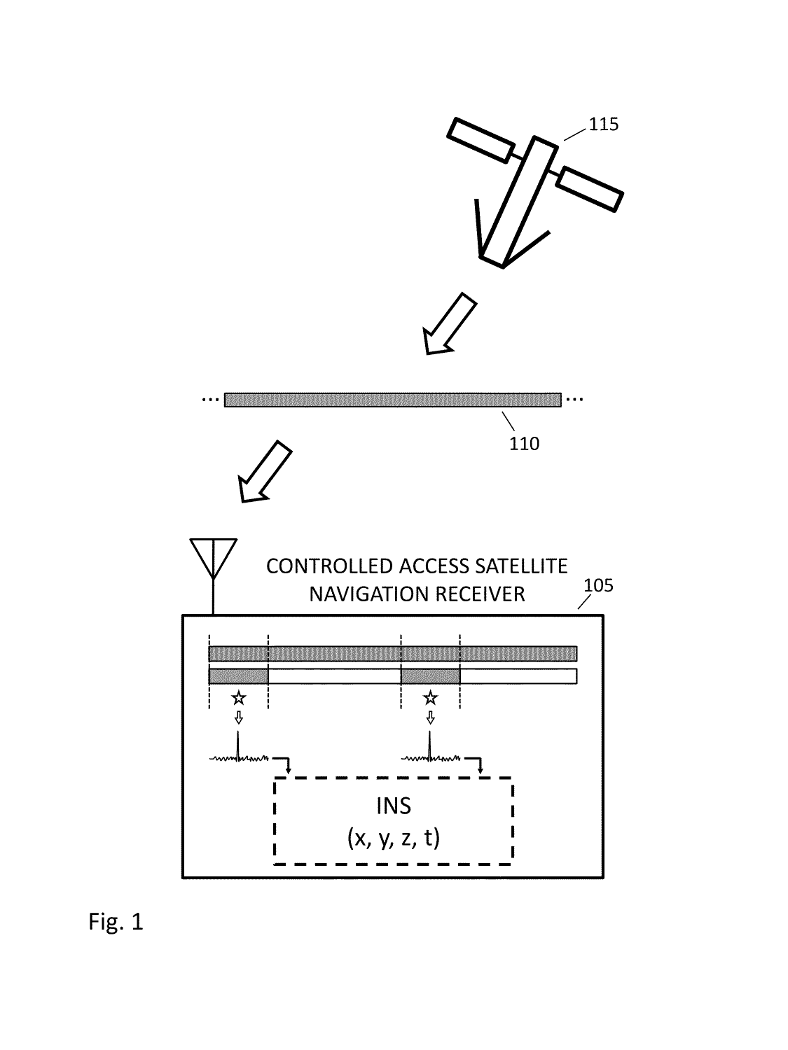

FIG. 1 is a conceptual diagram of a controlled access satellite navigation receiver receiving a signal from an orbiting satellite. In FIG. 1, controlled access receiver 105 receives a continuous code 110 from satellite 115. Receiver 105 has only incomplete knowledge of the code sent by the satellite; the receiver has, or can generate, only short code segments. It does not have, and cannot generate, continuous code or indefinitely long parts of it.

The receiver correlates its short code segments with the code received from the satellite to obtain satellite pseudoranges intermittently. This incomplete position information may then be used to authenticate or supplement alternate means of navigation such as an INS or a GNSS public code receiver. Authentication scenarios in which controlled access satellite receivers are useful include missile guidance, positioning for individual soldiers, and aircraft navigation. In each of these cases, a receiver with full knowledge of a secret code is impractical or undesirable.

GPS SAASM chips needed for generating P(Y) code are subject to US military control which limits their distribution. No matter how beneficial it might be to offer foreign airliners GPS spoofing protection when landing in the United States, as an example, they are not going to be given access to the P(Y) code. SAASM packaging is also bulky and increases the size and weight of GPS receivers. Thus a soldier equipped with non-SAASM anti-spoofing capability saves both weight and the worry associated with keeping equipment out of enemy hands. It is not possible to interpolate or extrapolate P(Y) code from these short segments. Thus, a controlled access receiver with short future P(Y) code segments does not present a security concern. (Past P(Y) code can be recorded directly from satellites. That doesn't help predict future code, in part because P(Y) encryption keys keep changing.)

Private satellite position (i.e. (\vec{x}, t) or components thereof) services may use controlled access receivers to provide varying levels of paid service. For example, a time service may be based on a continuous code broadcast by satellites. Controlled access receivers, having only short segments of the code, may update their internal clocks intermittently. Premium subscribers may be given more frequent and/or longer code segments while basic subscribers are given less frequent and/or shorter code segments. Premium subscribers' receivers then provide better accuracy than those of basic subscribers because their internal clocks are updated more often and/or with more precise time information.

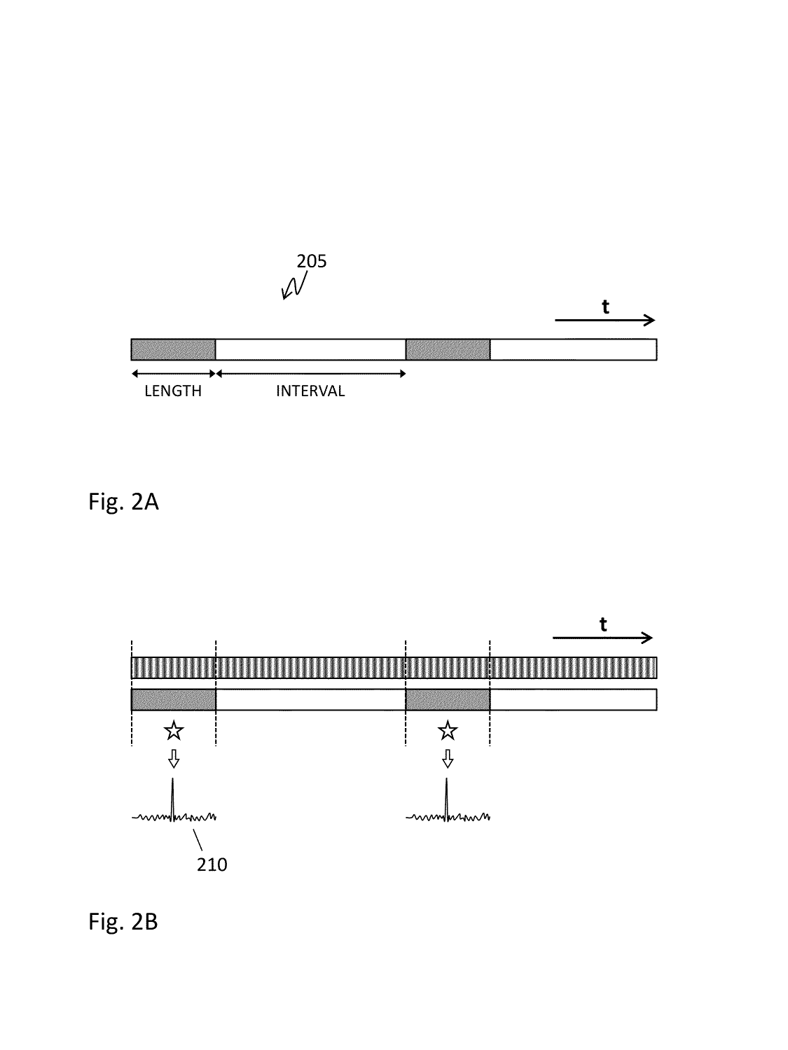

FIGS. 2A and 2B provide a more detailed look at incomplete secret codes available to controlled access satellite receivers. FIG. 2A is a conceptual diagram of code segments separated by intervals. FIG. 2B is a conceptual diagram of code segments correlated against a complete code.

In FIG. 2A, striped areas of timeline 205 indicate secret code segments or times during which a controlled access receiver has knowledge of a secret and otherwise unknown code. The code segments are characterized by their length which may be expressed in units of time or code chips. The code segments are separated by intervals which are periods of time when a controlled access receiver does not have access to a secret code.

FIG. 2B shows the code segments of FIG. 2A aligned with continuous secret code as received from a satellite. When a segment is aligned in time with the received code, correlation (suggested by a five-point star) produces a correlation peak (e.g. 210) from which pseudorange may be computed.

Secret codes such as those of FIGS. 2A and 2B may be pseudorandom noise (PRN) codes generated with shift registers and then encrypted. Alternatively, they may be memory codes that do not have a simple generating function. The minimum length of code segments provided to a controlled access satellite receiver is determined in part by the need to produce a correlation peak that can be reliably distinguished from noise. The longer the code segment, the more processing gain, the greater amplitude correlation peak and the more accurate pseudorange that can be computed. The maximum length of code segments is determined mainly by security considerations. In typical authentication applications, controlled access receivers need code segments no more than about 0.1% to about 1% of the time. Requirements for paid subscription services may vary, but in no case does a controlled access preceiver need code segments more than half the time. In other words the duty cycle of the code segments is always less than 50%. Further code segment strategies are described below.

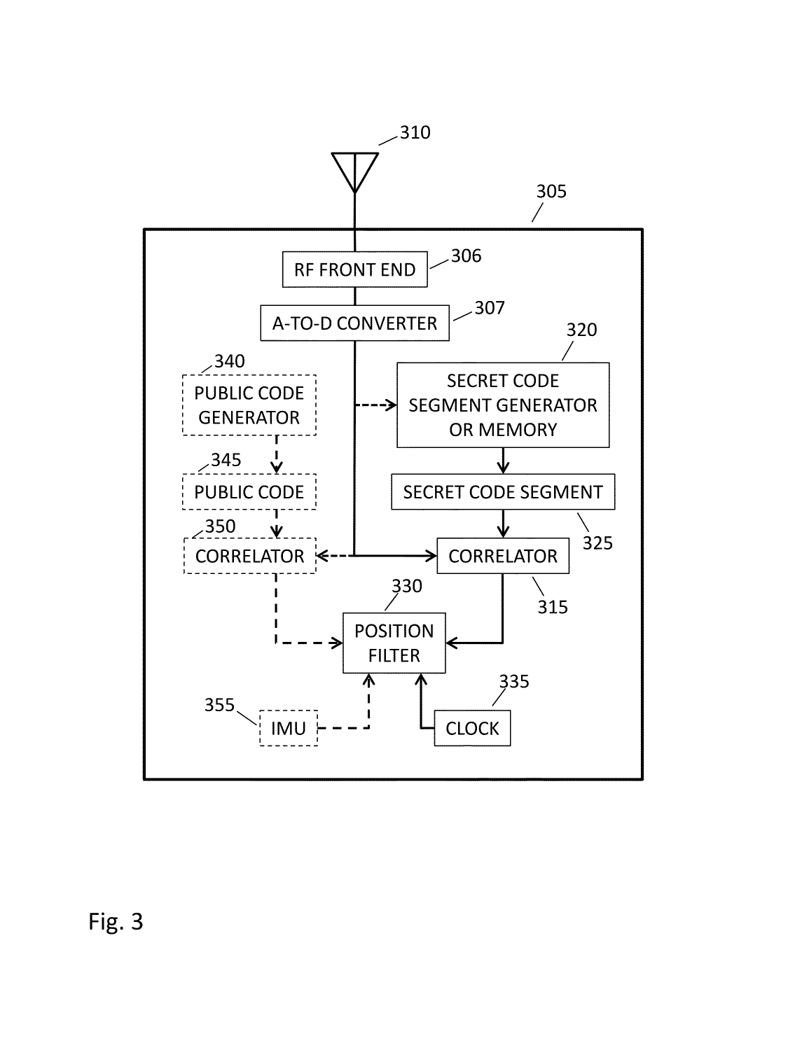

FIG. 3 is a simplified block diagram of a controlled access satellite navigation receiver 305. Receiver 305 uses intermittent position information obtained using incomplete secret codes to authenticate or supplement position obtained from other sources such as public GNSS signals and/or an INS. As described below, functional blocks having dashed outlines and signal paths indicated by dashed lines are optional components of the receiver.

Antenna 310 receives signals from satellites. An RF front end 306 and A-to-D converter 307 shift the satellite signals to baseband and transform them into the digital domain via sampling. These digital signals are then input to correlator 315. Secret code segment generator or secret code segment memory 320 produces segments of secret code such as 325. This generator or memory is incapable of generating continuous secret code or code segments of indefinite length. Applications involving short segments of GPS P(Y) code may be based on secret code memory that only stores short segments. That way there is no possibility of reverse engineering a controlled access receiver to find out the complete P(Y) code. Applications involving paid access may be based on secret code generators that are enabled and disabled at specific times programmed with permission granted via password, as an example. In short, the controlled access of the receiver is derived from its limited ability to generate secret code.

Correlator 315 correlates the received, digitized signal with the internally generated (or recalled) secret code segment. The resulting pseudorange is sent to position filter 330 which receives local time estimates from clock 335. Secret code segment memory 320 may receive encrypted code segments over the air via antenna 310 and associated RF components.

The receiver as described up to this point provides intermittent position estimates. Although this may be sufficient in some cases, many applications demand continuous position updates. Such updates may be obtained from a public code GNSS receiver, an IMU, a combination of the two, and/or other sources.

Public code generator 340, public code 345 and correlator 350 are illustrated as optional components of receiver 305. They generate pseudoranges which may be additional inputs to position filter 330. The update rate of a public code GNSS receiver is typically about 1 Hz-10 Hz depending on the number and quality of correlators available. (Availability of the public code does not limit update rates as it is known completely.) Optional IMU 355 may also provide position updates to position filter 330. MEMS-based or other types of IMU can update position estimates as fast as 100 Hz or more. The accuracy of IMU position estimates drifts between GNSS updates, however.

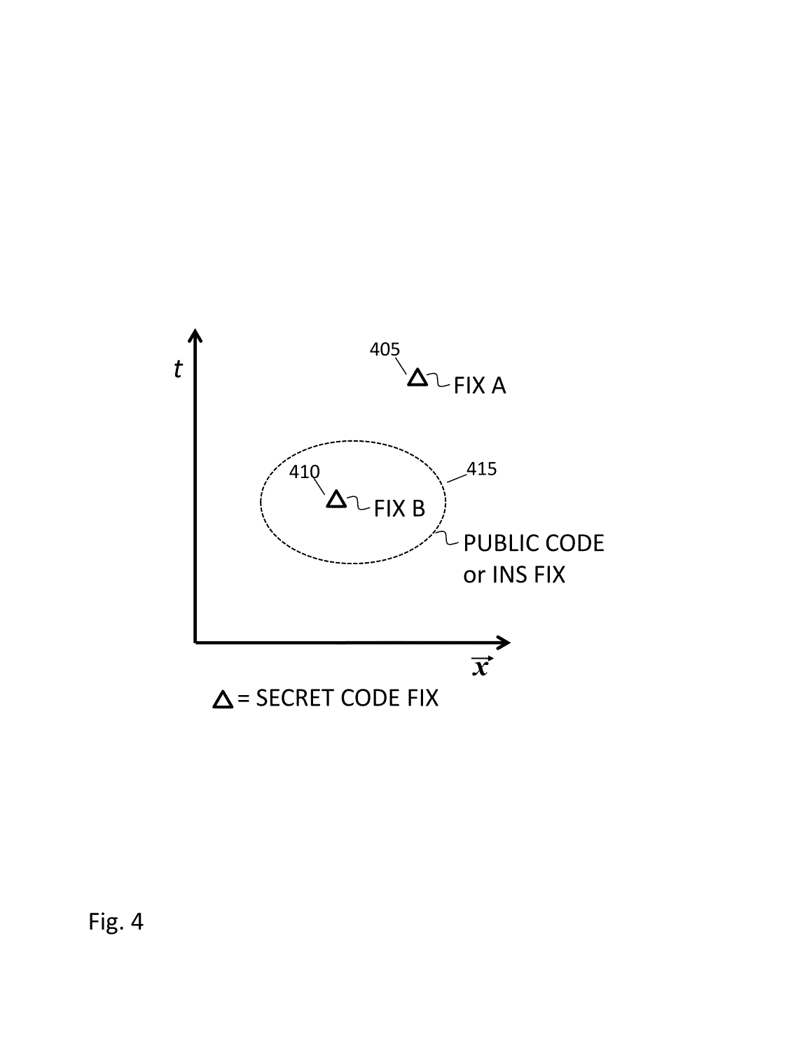

FIG. 4 is a snapshot of position uncertainties associated with different navigation systems, and provides further insight into the role of position filter 330 in FIG. 3. In FIG. 4 spatial position uncertainty is plotted on the \vec{x} axis while temporal position uncertainty is plotted on the t axis. Triangles (405, 410) represent position fixes based on secret code pseudoranges. Dashed oval (415) represents a position fix based on a public code GNSS receiver or an INS. In FIG. 4 this fix has greater uncertainty than the secret code fixes.

Position filter 330 of FIG. 3 may be configured in different ways depending on the type of position information available to it and how it is used. A controlled access receiver may be equipped with a public code GNSS receiver, an IMU, or both. The position filter may operate in the measurement domain, combining public and/or secret pseudoranges with IMU sensor data to estimate a position based on all available information. Alternatively, the position filter may operate in the position domain, comparing position fixes from various navigation sources with one another.

First, consider the case where receiver 305 may include IMU 355, but does not have a public code GNSS receiver (340, 345, 350). IMUs and clocks cannot be spoofed as they are self-contained; the accuracy of their position estimates drifts over time, however. In this case, position filter 330 uses intermittent secret code fixes (i.e. position estimates) to reset INS estimates. Uncertainty in INS position is periodically reduced to the uncertainty associated with a secret code fix whenever such a fix is available. In between secret code fixes, the uncertainty of INS estimates grows.

In a second scenario receiver 305 may include IMU 355 and does include public code GNSS receiver (340, 345, 350). If position filter 330 is configured to operate in the position domain, it compares public code fixes to secret code fixes. If public and secret code fixes are consistent with one another (e.g. their position uncertainties overlap or the distance between fixes is less than a threshold value), then the public code receiver has not been spoofed. In FIG. 4, secret fix “B” (410) is consistent with public fix 415 while secret fix “A” (405) is not. Given a finding of public code authenticity, the position filter may estimate position based only on public code pseudoranges (and optionally INS), or it may estimate position based on both public and secret code pseudoranges.

Alternatively, position filter 330 may compare public and secret pseudoranges. If public and secret pseudoranges are consistent with one another (e.g. the distance between them is less than a threshold value), then the public code receiver has not been spoofed.

Although FIG. 4 shows public code fix 415 having greater uncertainty that the secret code fixes, the opposite situation may occur. In particular, secret code fix uncertainty is increased when the length of secret code segments available to a controlled access receiver is short. In such a situation position filter 330 may use secret code fixes for authentication of public code fixes, but de-weight or exclude secret code pseudoranges in an overall estimate of position.

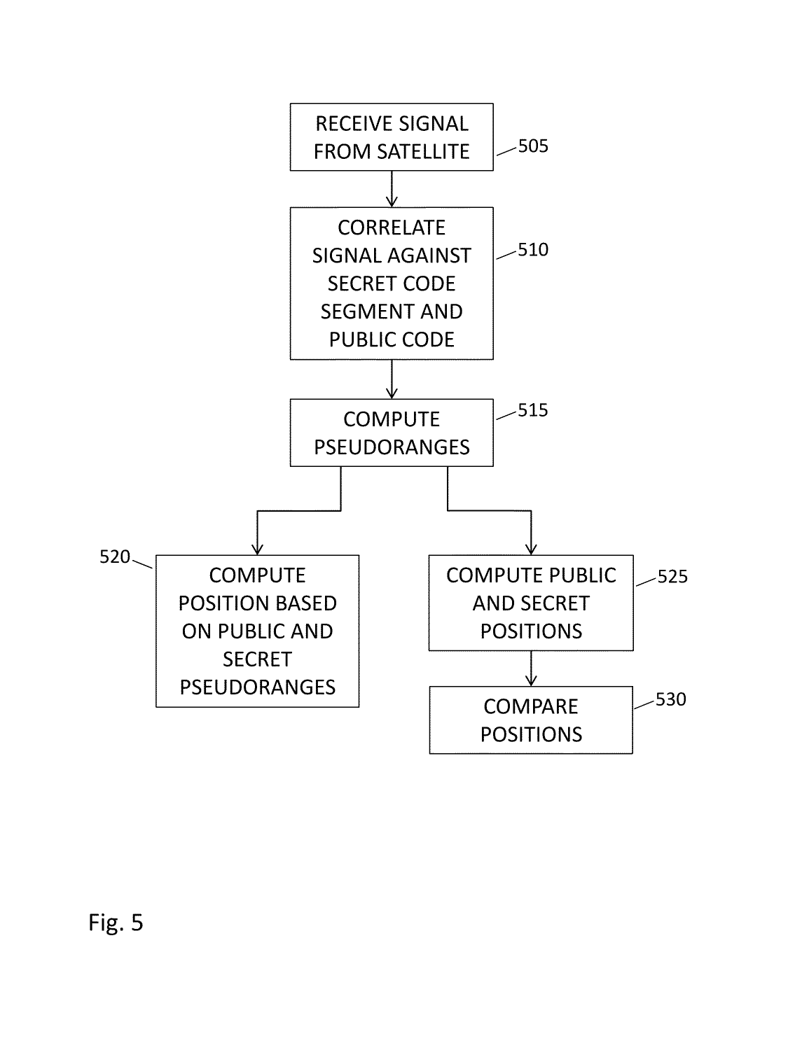

FIG. 5 is a flow chart for a controlled access satellite navigation method. The flow chart has two branches corresponding to operation of a position filter in the measurement domain or in the position domain. Step 505 in the flow chart is receiving a signal from a satellite. This step includes demodulating a radio signal in an RF front end and digitizing the signal in an analog-to-digital converter. Step 510 is correlating the signal against a secret code segment and also against a public code. Step 515 is computing pseudoranges from the correlations obtained in step 510.

A position filter operating in the measurement domain may perform step 520, computing an overall position estimate based on both public and secret pseudoranges and optionally on other information such as that provided by INS. On the other hand, a position filter operating in the position domain may perform step 525, computing separate position estimates based on public and secret pseudoranges considered separately. These public and secret position estimates may be compared in step 530.

A controlled access receiver may provide authentication by operating its position filter in the position domain and comparing public and secret position estimates. A controlled access receiver may correct drift (e.g. drift of a clock updated by a subscription satellite time service) by operating its position filter in the measurement domain and computing a best estimate of position based on all available information. Of course a receiver may be configured to operate in various modes at different times or to operate in various modes in parallel, simultaneously.

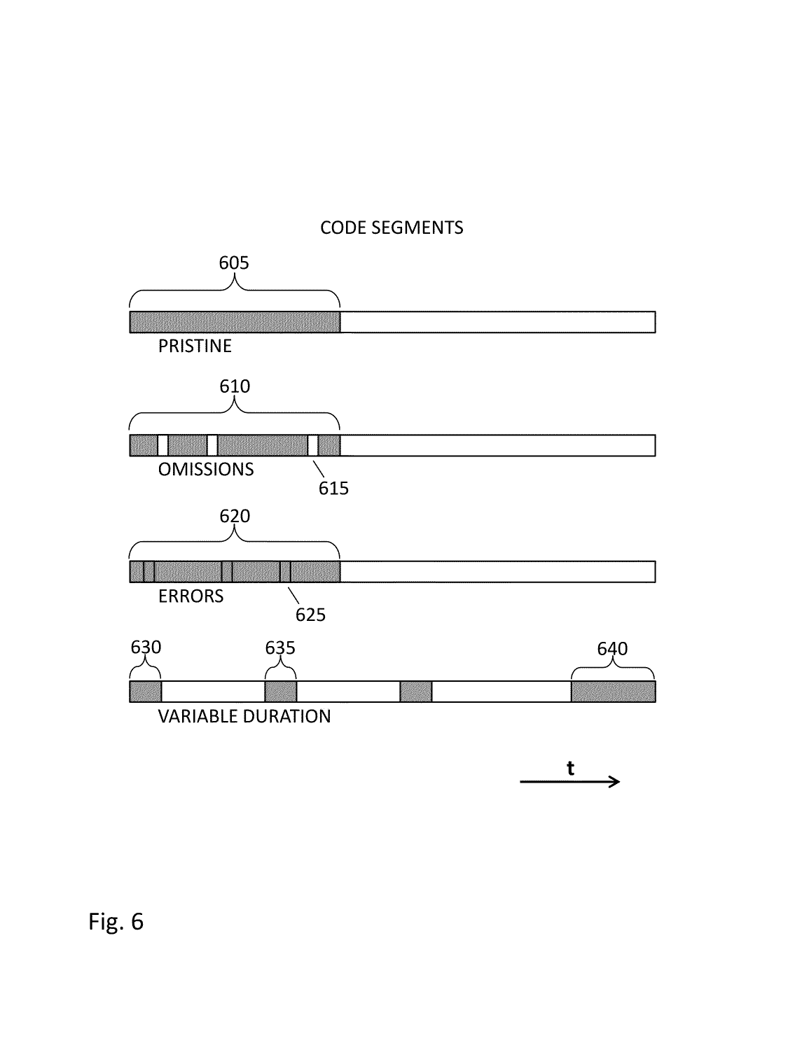

As described above, secret code segments allow a controlled access receiver to compute position updates only intermittently because of their low duty cycle. Secret code may be obtained for all times up to the present by listening to satellite broadcasts with a high-gain antenna; the secret aspect of a secret code is the ability to predict what it will be in the future. Code segments can be designed that reveal a secret code for the short times that they span, but are of no use in generating future code. FIG. 6 illustrates various code segment strategies.

In FIG. 6, four time lines illustrate a pristine code segment, a code segment with omissions, a code segment with errors, and variable duration code segments. A pristine code segment, e.g. 605, is one that contains the correct secret code for the time that it spans. Security of pristine code segments, i.e. confidence that they do not imply code at other times, is based on their short length. The generator polynomial for an Nth order shift register code cannot be deduced from code sequences shorter than 2N chips, for example. Thus pristine code segments do not betray shift register codes if the segments are shorter than 2N chips. Keeping the value of N secret also makes the generator polynomial harder to deduce.

Security of code segments may be further strengthened by introducing omissions or errors. Code segment 610 contains omissions indicated by blank times such as 615. Code segment 620 contains errors indicated by perpendicular hatching, e.g. 625. The effect of errors and omissions is similar, although errors are harder to detect. If a shift register code segment contains at least one error every 2N chips, then its Nth order generator polynomial can't be determined. Errors are harder to detect if they are not uniformly distributed in the code.

Code segments 630, 635 and 640 are illustrated in a timeline to demonstrate a variable duration code segment strategy. Segment 640 is longer than segments 630, 635. This strategy is directed to levels of paid service rather than code security. Longer code segments enable more precise correlation measurements. A paid service may provide precise information less frequently than general information.

Controlled access satellite navigation receivers are capable of only intermittent position determination when limited to use of secret code segments only. This limitation, however, lets them take advantage of secret codes without compromising secrecy. Secret codes may be used to authenticate other navigation signals, such as public codes, or to provide levels of access to paid services.

The above description of the disclosed embodiments is provided to enable any person skilled in the art to make or use the invention. Various modifications to these embodiments will be readily apparent to those skilled in the art, and the principles defined herein may be applied to other embodiments without departing from the scope of the disclosure. Thus, the disclosure is not intended to be limited to the embodiments shown herein but is to be accorded the widest scope consistent with the principles and novel features disclosed herein.

What is claimed is:

1. A controlled access satellite navigation receiver comprising:
a secret code segment memory that stores segments of a secret code to be transmitted by a satellite in the future;
a correlator that correlates signals received from the satellite with secret code segments retrieved from the memory; and,
a position filter that estimates position intermittently based on pseudoranges computed from secret code segment correlations.

2. The receiver of claim 1, the secret code segments generated by a secret code generator in the receiver.

3. The receiver of claim 1, the receiver obtaining secret code segments over the air in encrypted form.

4. The receiver of claim 1, further comprising a public code GNSS receiver that generates public code position estimates, and the position filter further comparing public and secret code position estimates.

5. The receiver of claim 4, the position filter indicating that the public code position estimate is authentic if it is consistent with the secret code position estimate.

6. The receiver of claim 1, further comprising an INS that generates position estimates, and the position filter further correcting INS drift whenever a secret code position estimate is available.

7. The receiver of claim 6, the INS including an IMU and a clock.

8. The receiver of claim 6, the INS being a clock.

9. The receiver of claim 1, the secret code being a memory code.

10. The receiver of claim 1, the secret code segments having a duty cycle of no more than 50% of the secret code.

11. A method for operating a controlled access satellite navigation receiver comprising:
receiving a signal from a satellite;
demodulating and sampling the signal to convert it to digital form;
correlating the signal against a secret code segment; and,
computing secret pseudoranges from the secret code segment correlation.

12. The method of claim 11 further comprising:
estimating position based on the secret pseudoranges.

13. The method of claim 12 further comprising:
correcting drift in an INS with the estimated position.

14. The method of claim 13, the INS including an IMU and a clock.

15. The method of claim 13, the INS being a clock.

16. The method of claim 11 further comprising:
estimating position based on the secret pseudoranges and INS measurements.

17. The method of claim 11 further comprising:
correlating the signal against a public code;
computing public pseudoranges from the public code correlation; and,
estimating position based on the public and secret pseudoranges.

18. The method of claim 11 further comprising:
estimating a first position based on the secret pseudoranges;
correlating the signal against a public code;
computing public pseudoranges from the public code correlation;
estimating a second position based on pseudoranges obtained with public code; and,
authenticating the second position estimate if it is consistent with the first position estimate.

19. The method of claim 11 further comprising:
correlating the signal against a public code;
computing public pseudoranges from the public code correlation;
estimating a position based on pseudoranges obtained with public code; and,
authenticating the position estimate if the secret and public pseudoranges are consistent.
